(19) United States
(12) Patent Application Publication
(10) Pub. No.: US 2010/0290117 A1
(43) Pub. Date: Nov. 18, 2010

(54) OPTICAL COMPENSATION FILM

(75) Inventors: Charles F. Diehl, Blue Bell, PA (US); Stephen F. Hahn, Midland, MI (US); Weijun Zhou, Lake Jackson, TX (US)

Correspondence Address: The Dow Chemical Company, P.O. BOX 1967, Midland, MI, 48641, US

(73) Assignee: DOW GLOBAL TECHNOLOGIES INC., Midland, MI (US)

(21) Appl. No.: 12/742,955

(22) PCT Filed: Sep. 17, 2008
(86) PCT No.: PCT/US2008/076582

§ 371 Date: May 20, 2010

Related U.S. Application Data
(60) Provisional application No. 60/989,154, filed on Nov. 20, 2007.

(51) Int. Cl. G02B 5/30; G02B 1/08

(52) U.S. Cl. 359/500

(57) ABSTRACT

Optically clear polymeric films, especially films fabricated from a hydrogenated vinyl aromatic block copolymer, that have a birefringence of from 0.001 to 0.05 and a retardation of from 25 nanometers to 500 nanometers, either as fabricated or as oriented post fabrication, function as, for example, optical compensation films or a layer in a multilayer film as an optical compensator for a display.

### CROSS-REFERENCE TO PRIOR APPLICATION

This application claims the benefit of U.S. Provisional Application No. 60/989,154 filed Nov. 20, 2007.

This invention relates generally to a polymeric film, especially a polymeric film that comprises a block copolymer such as a copolymer of a vinyl aromatic monomer and a diene (e.g. a conjugated diene such as 1,3-butadiene). This invention relates particularly to a polymeric film that comprises a hydrogenated block copolymer, preferably a substantially hydrogenated block copolymer and even more preferably a fully hydrogenated block copolymer. This invention relates more particularly to such films irrespective of whether they are in their unstretched or unoriented state (e.g. as melt cast) or in a stretched (uniaxial or biaxial) state. The polymeric films, whether stretched (oriented) or unstretched (unoriented) have utility as, for example, viewing angle enhancement of a liquid crystal display (LCD) television (TV) set, a quarter wave plate or an optical compensation element of some other display device.

One may describe an optically anisotropic film in terms of three principal and orthogonal refractive indices, nx, ny and nz, wherein x and y typically define a film plane in terms of, respectively, length and width, and z commonly refers to film thickness. Optical anisotropy most often occurs when nx either exceeds ny or ny exceeds nx, especially for very thin films (e.g. a thickness of less than 250 micrometers (μm)), but may also occur when nz either exceeds or is less than one or both of nx and ny.

As used herein, “birefringence” refers to a difference between any two of the three principal and orthogonal refractive indices. In a relationship where nx is greater than (>) ny and ny equals (=) nz, birefringence or Δn in film plane=nx−ny and Δn in a plane defined by y and z=0.

One may also describe optical anisotropy in terms of retardation or retardation values. Film in-plane retardation (R₀) may be represented by an equation wherein R₀=(nx−ny)d where d equals film thickness. Film out-of-plane (e.g. thickness direction) retardation or Rₜₕ may be represented by an equation wherein Rₜₕ=(nx−nz)d or (((nx+ny)/2)−nz)d.

United States Patent Application Publication (USPAP) 2006/0257078 to Kawahara et al. discloses retardation films that comprise a stretched polymeric film wherein the film contains a norbornene-based resin. Kawahara et al. suggests that the stretched film “is suitable for compensating for a viewing angle of a liquid crystal cell of TN mode, VA mode, IPS mode, FFS mode or OCB mode”.

A first aspect of this invention is a polymeric film, preferably an optical compensation film, that has a birefringence within a range of from 0.001 to 0.05, an in-plane retardation (R₀) within a range of from 25 nanometers (nm) to 500 nm at a wavelength of 633 nm, and, in its unstretched state, three mutually orthogonal refractive indices, nx, ny and nz, provided that one of the refractive indices has a magnitude that exceeds the other two refractive indices and constitutes a slow axis, the slow axis having a direction that is consistent, within a standard deviation of ten degrees, from one film region to another film region. Determine slow axis consistency by use of, or reference to, substantially gel-free regions of the film.

A second aspect of this invention is a stretched polymeric film, the film comprising a polymer that has a crystallinity within a range of from 0.5 percent by weight to less than 20 percent by weight of the total polymer and having a birefringence within a range of from 0.001 to 0.05 at a wavelength of 633 nm, and an in-plane retardation (R₀) within a range of from 25 nm to 500 nm.

The films of the first and second aspects of this invention have utility in a variety of end use applications, especially optical applications. Typical optical applications include compensation films as well as polarizer films, anti-glare films, quarter wave plate, anti-reflective films, and brightness-enhancing films.

In a monograph entitled “Fundamentals of Liquid Crystal Devices”. John Wiley & Sons, Ltd. (2006) Deng-Ke Yang and Shin-TsonWu discuss classification of an optically birefringent film. They classify an uniaxial film as an anisotropic birefringence film with only one optical axis, also known as a “principal optical axis”. The principal optical axis equates to an axis along which the uniaxial film has an index of refraction that differs from a substantially uniform index of refraction along directions perpendicular to the principal optical axis. Uniaxial films typically fall into one of two classes, nominally “a-plate” and “c-plate”. The principal optical axis of an a-plate is parallel to the film's surface (i.e. ny=nz, but ny and nz differ from nx), while the principal optical axis of a c-plate is perpendicular to the film's surface (i.e. nx=ny, but nx and ny differ from nz). One can further subdivide both a-plate and c-plate uniaxial films into positive or negative films depending on the relative values of an extraordinary refractive index “ne” and an ordinary refractive index “no”. Positive a-plate and c-plate films have an optical axis, otherwise known as a “slow axis”, that corresponds to greatest of the three mutually orthogonal indices of refraction noted above. Negative a-plate and c-plate films have an optical axis, otherwise known as a “fast axis” that corresponds to the smallest of the three mutually orthogonal indices of refraction noted above. An additional class of uniaxial films, nominally “O-plate” films, has the principal optical axis tilted with respect to the film surface.

A biaxial optical film or plate refers to a birefringent optical element that has three unequal, mutually orthogonal indices of refraction. In other words, nx≠ny≠nz. Parameters used to describe biaxial optical films include in-plane retardation (R₀) and out-of-plane retardation (Rₜₕ). As R₀ approaches zero, the biaxial film or plate behaves more like a c-plate. A typical biaxial optical film or plate has an R₀ of at least 5 nm at a wavelength of 550 nm.

The definition of “slow axis” noted above applies to uniaxial positive a-plate, uniaxial negative a-plate, biaxial films and uniaxial O-plate. For positive c-plate, the slow axis equates to the principal optical axis direction (i.e., film thickness direction). For negative c-plate films, there is no real slow axis because nx=ny>nz.

When ranges are stated herein, as in a range of from 2 to 10, both end points of the range (e.g. 2 and 10) and each numerical value, whether such value is a rational number or an irrational number, are included within the range unless otherwise specifically excluded.

References to the Periodic Table of the Elements herein shall refer to the Periodic Table of the Elements, published and copyrighted by CRC Press, Inc., 2003. Also, any references to a Group or Groups shall be to the Group or Groups reflected in this Periodic Table of the Elements using the IUPAC system for numbering groups.

Unless stated to the contrary, implicit from the context, or customary in the art, all parts and percents are based on weight. For purposes of United States patent practice, the contents of any patent, patent application, or publication referenced herein are hereby incorporated by reference in their entirety (or the equivalent US version thereof is so incorporated by reference) especially with respect to the disclosure of synthetic techniques, definitions (to the extent not inconsistent with any definitions provided herein) and general knowledge in the art.

The term “comprising” and derivatives thereof does not exclude the presence of any additional component, step or procedure, whether or not the same is disclosed herein. In order to avoid any doubt, all compositions claimed herein through use of the term “comprising” may include any additional additive, adjuvant, or compound whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed. The term “or”, unless stated otherwise, refers to the listed members individually as well as in any combination.

Expressions of temperature may be in terms either of degrees Fahrenheit (° F.) together with its equivalent in ° C. or, more typically, simply in ° C.

Films of this invention, especially optical compensation films, preferably comprise a block copolymer, more preferably a hydrogenated vinyl aromatic/butadiene block copolymer in which both vinyl aromatic blocks and butadiene blocks are substantially fully hydrogenated, and still more preferably a hydrogenated styrene/butadiene block copolymer in which both vinyl aromatic blocks and butadiene blocks are substantially fully hydrogenated. Illustrative preferred styrene/butadiene block copolymers include styrene/butadiene/styrene (SBS) triblock copolymers and styrene/butadiene/styrene/butadiene/styrene (SBSBS) pentablock copolymers, in each case wherein the styrene and butadiene blocks are substantially fully hydrogenated.

As used herein, “substantially fully hydrogenated” means that at least 90 percent of double bonds present in vinyl aromatic blocks prior to hydrogenation are hydrogenated or saturated and at least 95 percent of double bonds present in diene blocks prior to hydrogenation are hydrogenated or saturated.

U.S. Pat. No. 6,632,890 to Bates et al., the relevant teachings of which are incorporated herein by reference, discloses hydrogenated block copolymers, based upon block copolymers having vinyl aromatic blocks and conjugated diene polymer blocks polymerized therein as well as preparation of such hydrogenated block copolymers. Such hydrogenated block copolymers comprise at least two blocks of hydrogenated, polymerized vinyl aromatic monomer and at least one block of hydrogenated, polymerized diene monomer. Hydrogenated triblock copolymers have two blocks of hydrogenated, polymerized vinyl aromatic monomer, one block of hydrogenated, polymerized diene monomer and a total number average molecular weight of from 30,000 to 120,000. Hydrogenated pentablock copolymers have three blocks of hydrogenated, polymerized vinyl aromatic monomer, two blocks of hydrogenated, polymerized diene monomer and a total number average molecular weight of from 30,000 to 200,000. Each hydrogenated vinyl aromatic polymer block has a hydrogenation level of greater than 90 percent and each hydrogenated conjugated diene polymer block has a hydrogenation level of at least 90 percent. See also U.S. Pat. No. 5,612,422 to Hucul et al. for hydrogenation of aromatic polymers with a focus upon silica-supported hydrogenation catalysts.

U.S. Pat. No. 6,350,820 to Hahnfeld et al. discloses similar hydrogenated polymers with a total number average molecular weight (Mₙ) of 30,000 to 150,000 and a requirement for a hydrogenated diene block length of 120 monomer units or less. Hahnfeld et al. characterizes the hydrogenated polymers as having surprisingly negligible birefringence.

The block copolymer, prior to hydrogenation, preferably prior to hydrogenation and formation into a film, is a styrene/butadiene block copolymer that has a styrene content within a range of from 50 percent by weight (wt %) to less than 80 wt % and a butadiene content within a range of from 50 wt % to at least 20 wt %, each percentage being based upon total block copolymer weight and, when taken together equal 100 wt %. As styrene content falls below 50 wt %, particularly as it falls to 40 wt % or less, dimensional stability of a film prepared from such a polymer begins to lessen. The styrene content range is more preferably from 55 wt % to less than 80 wt % and still more preferably from 60 wt % to less than 80 wt %. Conversely, the butadiene content range is more preferably from 45 wt % to at least 20 wt % and still more preferably from 40 wt % to at least 20 wt %. The block copolymer preferably has a Mₙ within a range of from 40,000 to 150,000. The Mₙ range is more preferably from 40,000 to 120,000, still more preferably from 40,000 to 100,000 and even more preferably from 50,000 to 90,000. A film prepared from a polymer with a Mₙ of less than 40,000 typically demonstrates less than desirable, some would say “poor”, physical or mechanical properties. Preparation of a film or molded article from a polymer with a Mₙ in excess of 150,000 tends to be more difficult than preparation of such a film or molded article from a polymer with a Mₙ within the range of from 40,000 to 150,000. The block copolymer is preferably a triblock copolymer or a pentablock copolymer, with especially good results following use of a pentablock copolymer. By way of illustration, when the vinyl aromatic monomer is styrene (represented as “S”) and the diene monomer is butadiene (represented as “B”), a triblock copolymer may be shown as SBS and a pentablock copolymer may be shown as SBSBS. In other words, the block copolymers have a polymerized vinyl aromatic monomer (e.g. polystyrene) block at each end of the polymer prior to hydrogenation. One may use a blend of two or more block copolymers (e.g. two or more triblock copolymers, two or more pentablock copolymers or at least one triblock copolymer and at least one pentablock copolymer) if desired.

One may also blend a non-block polymer or copolymer with the block copolymer(s) such that the films of the first and second aspect further comprise an amount of a non-block copolymer. Illustrative non-block polymers and copolymers include, but are not limited to, hydrogenated vinyl aromatic homopolymers, polyolefins, cyclo olefin polymers, cyclo olefin copolymers, acrylic polymers, acrylic copolymers and mixtures thereof. The non-block polymer or copolymer, when blended with a block copolymer, is miscible with, and sequestered within, at least one phase of the block copolymer. The amount of non-block polymer preferably falls within a range of from 0.5 wt % to 50 wt %, based upon combined weight of block copolymer and non-block copolymer. The range is more preferably from 1 wt % to 40 wt % and still more preferably from 5 wt % to 30 wt %.

Additional illustrative non-block copolymers include a polymer (e.g. a homopolymer, a random copolymer or an interpolymer) selected from a group consisting of vinyl aromatic homopolymers and hydrogenated random copolymers of a vinyl aromatic monomer and a conjugated diene.

As used herein, “homopolymer” refers to a polymer having polymerized therein a single monomer (e.g. styrene monomer in a polystyrene homopolymer). Similarly, “copolymer” refers to a polymer having polymerized therein two different monomers (e.g. styrene monomer and acrylonitrile monomer in a styrene acrylonitrile copolymer) and “interpolymer” refers to a polymer having polymerized therein three or more different monomers (e.g. ethylene monomer, propylene monomer and a diene monomer in an ethylene/propylene/diene monomer (EPDM) interpolymer).

A portion of the butadiene content comprises 1,2-butadiene. The portion is preferably less than 40 wt %, more preferably less than or equal to 30 wt %, yet more preferably less than or equal to 20 wt %, even more preferably less than or equal to 15 wt %, and still more preferably less than or equal to 10 wt %, in each case based upon total butadiene content. With a 1,2-butadiene content in excess of 40 wt %, hydrogenated vinyl aromatic/diene block copolymers, especially hydrogenated styrene/butadiene block copolymers and even more particularly with hydrogenated styrene/butadiene pentablock (SBSBS) copolymers, have a percent crystallinity that is too low to allow use of such polymers in optical compensation film applications. A hydrogenated styrene/diene block copolymer that either lacks crystallinity or has a very low crystallinity (e.g., <0.5 wt % crystallinity based on Differential Scanning Calorimetry (DSC) analysis) does not yield a film with a retardation that is high enough to meet industry standards for compensation films, irrespective of whether one prepares such a film by melt casting or by a process that induces film orientation.

The polymeric film of this invention, is preferably a film suitable for use as an optical compensation film. The film preferably comprises a block copolymer, more preferably a hydrogenated block copolymer, still more preferably a substantially fully hydrogenated block copolymer, and even more preferably a fully hydrogenated block copolymer. The hydrogenated block copolymer preferably has a hydrogenation percentage such that at least 90 percent of double bonds present in vinyl aromatic blocks prior to hydrogenation are hydrogenated or saturated and at least 95 percent of double bonds present in diene blocks prior to hydrogenation are hydrogenated or saturated.

The polymeric film of this invention has certain physical properties and physical parameters. For example, the film has an average percent spectral transmittance, as measured in accord with ASTM E-1348 method using a spectrophotometer and a wavelength range of from 380 nm to 780 nm, of at least 80 percent. The average percent spectral transmittance is preferably at least 85 percent, and more preferably at least 88 percent. If the average percent spectral transmittance is less than 80 percent, displays that include such a film as a compensation film, tend to have a brightness that is less than that attainable with an average percent spectral transmittance of 80 percent or more.

The polymeric film of this invention also has a dimensional stability, as determined in accord with durability testing at 60° C. and 90% relative humidity (high humidity conditions) or 80° C. and 5% relative humidity (high temperature conditions) for a period of 24 hours, sufficient to limit dimensional changes to less than 1% (percent), more preferably less than or equal to 0.5% in at least one of film length and film width. The film further has a retardation uniformity for R₀ in terms of its standard deviation of no more than 15 nm, preferably no more than 12 nm, more preferably no more than 10 nm, and still more preferably no more than 5 nm. If the standard deviation for R₀ or in-plane retardation, is too high, e.g. in excess of 15 nm, viewing angle performance of a device that incorporates such a film as a compensation film tends to decrease to an unacceptable level.

Films of the present invention, which may be monolayer films or at least one layer of a multilayer film, have a thickness that preferably falls within a range of from 10 micrometers (μm) to 300 μm. The range is more preferably from 25 μm to 250 μm and still more preferably from 30 μm to 150 μm. A film with a thickness of less than 10 μm leads to handling and post-processing challenges, especially in lamination, that make it less than desirable. A film with a thickness in excess of 300 μm increases cost, relative to a film with a thickness of from 10 μm to 300 μm, and may also have a retardation that is too high for use as a compensation film.

Films of the present invention more desirably, often preferably, further comprise an amount of a retardation-enhancing agent. As used herein, “retardation enhancing agent” means an additive that can alter an optical polymer film's in-plane retardation R₀ or out-of-plane retardation Rₜₕ by at least 20 nm compared to the same optical polymer film without the use of a retardation enhancing agent. The amount is preferably within a range of from 0.01 wt % to 30 wt %, more preferably from 0.1 wt % to 15 wt % and still more preferably from 0.5 wt % to 10 wt %, in each case based upon total weight of polymer (block copolymer and, when present non-block polymer) and retardation-enhancing agent.

Illustrative retardation-enhancing agents include compounds having a rod shape or a disc shape. These agents typically have at least two aromatic rings. Rod-shaped compounds preferably have a linear molecular structure. The rod-shaped compounds also preferably exhibit liquid crystal properties, especially when heated (i.e., thermotropic liquid crystal). Liquid crystal properties appear, for example, in a liquid crystal phase, preferably a nematic phase or smectic phase. A number of references discuss rod-shaped compounds. See, e.g., Journal of the American Chemical Society (J. Amer. Chem. Soc.), volume (vol.) 118, page 5346 (1996); J. Amer. Chem. Soc., vol. 92, page 1582 (1970); Molecular Crystals Liquid Crystals (Mol. Cryst. Liq. Cryst.), vol. 53, page 229 (1979); Mol. Cryst. Liq. Cryst., vol. 89, page 93 (1982); Mol. Cryst. Liq. Cryst., vol. 145, page 111 (1987); Mol. Cryst. Liq. Cryst., vol. 170, page 43 (1989); and Quarterly Review of Chemistry by The Chemical Society of Japan, No 22, 1994.

Disc-shaped retardation compounds preferably have an aromatic heterocyclic group in addition to an aromatic hydrocarbon ring. Examples of suitable retardation-enhancing agents include: benzene derivatives disclosed by C. Destrade, et al. in Molecular Crystallography (Mol. Cryst.), vol. 71, page 111 (1981); truxene derivatives disclosed by C. Destrade, et al. in Mol. Cryst., vol. 122, page 141 (1985); cyclohexane derivatives disclosed by B. Kohne, et al. in Angew. Chem., vol. 96, page 70 (1984); and azacrown-based and phenylacetylene-based macrocycles disclosed by J. Zhang et al. in J. Am. Chem. Soc., vol. 116, page 2655 (1994).

Films of the first aspect of this invention, in their unstretched state, have three refractive indices, a machine direction refractive index (nx), a transverse direction refractive index (ny) and a thickness direction refractive index (nz). One of the refractive indices nx, ny and nz must have a magnitude that exceeds the other two refractive indices and constitutes a slow axis. The magnitude by which one refractive index exceeds the other two refractive indices is preferably at least 8×10⁻⁵ (also known as a “minimum amount”), more preferably at least 0.0001, still more preferably at least 0.001, and even more preferably at least 0.002. A minimum amount less than 0.0001 (e.g. 8×10⁻⁵) equates to a maximum retardation of 25 nm for a film with a thickness of 250 μm. Current specifications for compensation films require a retardation in excess of 25 nm.

Stretched films of the second aspect of this invention, have a crystallinity of from 0.5 percent by weight (wt %) to less than 20 wt %, based upon total film weight. The crystallinity is preferably at least one wt %.

Films of the present invention, whether of the first aspect or the second aspect, have an in-plane retardation (R₀) within a range of from 25 nm to 500 nm at a wavelength of 633 nm. The films preferably have in-plane retardation (R₀) uniformity, in terms of standard deviation of R₀, of no more than 15 nm at a wavelength of 633 nm. The film can exhibit either uniaxial or biaxial anisotropic birefringence property irrespective of whether it is an unstretched or a stretched film.

Films of this invention preferably result from a melt extrusion or melt casting procedures such as those taught in Plastics Engineering Handbook of the Society of Plastics Industry, Inc., Fourth Edition, pages 156, 174, 180 and 183 (1976). Typical melt casting procedures include use of a melt extruder, such as a mini-cast film line manufactured by Killion Extruders, Inc., operating with set point temperatures, extruder screw speed, extruder die gap settings and extruder back pressure sufficient to convert a polymer or blend of polymers from a solid (e.g. granular or pellet) state to a melt state or molten polymer.

Use of a conventional film forming die, such as a “T-die” disclosed in U.S. Pat. No. 6,965,003 (Sone et al.) or a “coat hanger die” disclosed in Modern Plastics Handbook, Edited by Modern Plastics; Charles A Harper. (McGraw-Hill, 2000), Chapter 5, Processing of Thermoplastics, page 64-66, yields a film meeting physical property and performance parameters noted hereinabove. Skilled artisans readily understand that no single film processing parameter determines resulting film characteristics. Rather, multiple film processing parameters (e.g. melt temperature, cast roll temperature, die gap, draw down ratio, chill roll temperature and line speed) as well as film composition (e.g. polymer composition and, when present, additives) interrelate sufficiently that one must make adjustments to multiple parameters to yield a desirable film, which adjustments are well within reach of a skilled artisan and do not constitute undue experimentation.

As noted above, films of this invention may be a monolayer or one layer of a co-extruder multilayer film. When desirable, film of this invention, irrespective whether it is a monolayer or multilayer, may be further laminated to other optical films to form a film structure with unique anisotropic birefringence property that can not be readily achieved by a stretched polymeric film. Particular examples of those compensation film structures include, but not limited to, positive and negative biaxial plate, positive and negative C-plate, negative wavelength dispersion plate. For a negative wavelength dispersion film or plate, the retardation is larger at a longer wavelength than at a shorter wavelength (e.g., R₀ at 450 nm<R₀ at 550 nm<R₀ at 650 nm).

Typical melt extrusion conditions for a film that need not be stretched after preparation to function as a compensation film (also known as an “as cast film”) include conversion of a hydrogenated block copolymer resin to a polymer melt at a temperature within a range of from T_{ODT}−20° C. (degrees centigrade) to T_{ODT}+35° C., preferably from T_{ODT}−10° C. to T_{ODT}+30° C., and more preferably from T_{ODT}−10° C. to T_{ODT}+28° C. In preparing a film that is to be stretched, one may increase the upper temperature limits up to but not exceeding, a temperature at which the hydrogenated block copolymer resin undergoes thermal degradation. As used herein, T_{ODT} means a temperature at which a block copolymer loses discrete, periodic morphological order and transitions to a substantially homogeneous melt of chains. A small angle X-ray scattering (SAXS) image of a hydrogenated block copolymer in its ordered state is highly anisotropic. Conversely, a SAXS image of a hydrogenated block copolymer in a disordered state shows no detectable amount of anisotropy, because individual polymer chains start to assume a random coil configuration. When polymer melt temperature exceeds a polymer's T_{ODT}, a cast film from such a polymer melt tends to be very transparent and have very low haze. When the polymer melt temperature falls well below a polymer's T_{ODT} (e.g. more than 30° C. below the T_{ODT}), optical transparency of a cast film can be influenced by fabrication conditions. In some cases, such a film may appear to be slightly hazy, possibly due to microscale roughness on the film surface. In the latter case, a subsequent film orientation/stretching step (either biaxial or uniaxial) at a temperature above the polymer's glass transition temperature (T_{g}) may be employed to improve the transparency of such films. Such microscale roughness may be developed as a result of high polymer melt elasticity at those film processing conditions, and does not appear to be due to macrophase separation of a block copolymer.

Ian Hamley discusses T_{ODT} measurements in The Physics of Block Copolymers, pages 29-32, Oxford University Press, 1998, the teachings of which are incorporated herein to the maximum extent permitted by law. In brief, one can identify an order-disorder transition either by rheological techniques or by small-angle x-ray scattering. Dynamic rheological characterization enables one to find a discontinuity in low frequency elastic modulus during a ramp up in heating. Because the disordering process is observed in amorphous polymeric melts, this phenomena can be clearly differentiated from melting or glass transitions. Alternately, one can conduct frequency sweeps at temperatures around an expected T_{ODT} and plot shear storage modulus (G′) and shear loss modulus (G″) with respect to frequency. The slopes of G′ and G″ with respect to frequency coalesce at 2 and 1, respectively, at the T_{ODT}. An order-disorder transition also shows up as a significant change in both peak intensity and peak width of small-angle x-ray peaks. The temperature at which the significant change begins equals the T_{ODT}. Skilled artisans recognize that some small variation in T_{ODT} may occur between the two techniques, rheological and small-angle x-ray scattering, very probably due to differing physical methods used to assess changes occurring within the polymer as it proceeds through T_{ODT} determination. As long as one uses a single technique for all polymers in a series or grouping, one can differentiate polymers based upon their T_{ODT}.

An “unstretched” (or “unoriented”) film means a film made by extrusion casting (or calendaring) and used as is. Preparation of such films does not involve a separate processing step of orientating a film by stretching it under heat (e.g. at a temperature at or above the glass transition temperature of the polymer used to make the film). Skilled artisans recognize that some degree of orientation inevitably occurs in a cast film during one or both film casting itself and winding of a cast film into a roll for further processing. This invention excludes such inevitable degree of orientation from its definition of “orientation” or “oriented”.

Conversely, preparation of a “stretched” (or “oriented”) film does include a separate processing step that follows preparation of a film made by extrusion casting (or calendaring). The separate processing step involves orienting or stretching a film, either uniaxially or biaxially, at a temperature at or above the glass transition temperature of the polymer used to make the film. For more information on well-known methods of film orientation or film stretching, see, e.g., a monograph entitled “Plastic Films” by John H. Briston, Chapter 8, page 87-89, Longman Scientific & Technical (1988).

While melt extrusion represents a preferred means or process of fabricating films of this invention, one may use other, less preferred techniques if desired. For example, one may use solvent casting, recognizing that solvent handling and solvent removal pose additional challenges, including environmental challenges. One may also prepare films via pressed film procedures, provided one accepts at least some measure of non-uniform optics in a pressed film. As used herein, “non-uniform optics” means either a standard deviation for magnitude of optical retardation in excess of 15 nm or a direction of slow axis from one film region to another film region variation in excess of 10 degrees.

While films of this invention preferably find use in their unstretched (also known as unoriented) state, one may stretch such films in at least one of film machine direction or film transverse direction. Skilled artisans typically refer to machine direction orientation as orientation in an extrusion direction and transverse direction orientation as orientation normal to the extrusion direction. Orientation in a single direction (e.g. machine direction) yields a uniaxially oriented film. Similarly, orientation in two directions (e.g. machine direction and transverse direction), whether conducted simultaneously or as two separate steps, yields a biaxially oriented film. Skilled artisans readily understand orientation procedures and processes for handling both oriented and unoriented films.

Films of this invention have, as skilled artisans readily understand, two spaced apart and substantially parallel major surfaces. The surfaces, for a flat film, are both substantially parallel and planar. In an embodiment of this invention, either or both of such major surfaces have a coating deposited thereon. Such coatings may include, for example, at least one additive selected from a group consisting of retardation-enhancing agents, polarization-modifying agents and dye molecules. In another embodiment of this invention, films of this invention have incorporated therein, at least one of said additives. In yet another embodiment of this invention, films of this invention coated films also have at least one of said additives incorporated into the films prior to coating. In addition to said additives, one may also incorporate into a film, and in some cases into a film coating, one or more conventional additives such as an antioxidant, an ultraviolet (UV) light stabilizer, a plasticizer, a release agent or any other conventional additive used in fabricating polymeric films.

Films of this invention, whether monolayer films or one or more layers of a multi-layer films, have utility in a variety of end use applications, one of which is a liquid crystal display, an application that makes advantageous use of film optical clarity and other physical properties and performance characteristics as noted herein. When used as a liquid crystal display, the display is either a VA mode display or an IPS mode display.

### EXAMPLES

The following examples illustrate, but do not limit, the present invention. All parts and percentages are based upon weight, unless otherwise stated. All temperatures are in ° C. Examples (Ex) of the present invention are designated by Arabic numerals and Comparative Examples (Comp Ex or CEx) are designated by capital alphabetic letters. Unless otherwise stated herein, “room temperature” and “ambient temperature” are nominally 25° C.

Determine T_{ODT} of hydrogenated styrenic block copolymers by first compression molding, at a temperature of 230° C., an aliquot of the copolymer into a circular, disk-shaped specimen having a diameter of 25 millimeters (mm) and a thickness of 1.5 mm. Subject the specimens to dynamic rheological characterization to find a discontinuity in low frequency elastic modulus during a ramp up in heating at a rate of 0.5° C. per minute over a temperature range of from 160° C. to 300° C. using a parallel plate rheometer (ARES rheometer, TA Instruments, New Castle, Del.) operating at an oscillatory frequency of 0.1 radians per second (rad/sec) and a strain amplitude of one percent. T_{ODT} determinations made in this manner have an accuracy of ±5° C. If this test reveals no discontinuity in low frequency elastic modulus over the 160 to 300 temperature range, it implies that the polymer has a T_{ODT} outside of this temperature range rather than that it lacks a T_{ODT}.

Measure optical retardation of a film sample using an EXICOR™ 150ATS (Hinds Instrument) apparatus and a wavelength of 633 nm by selecting a square section (6 centimeters (cm) by 6 cm) of film located in the middle section of the film sample surface and making at least 100 independent optical retardation measurements of birefringence and optical retardation. Report an average of in-plane retardation (R₀) and direction of slow axis and calculate standard deviation of R₀ based upon all independent measurements made on that section of film.

Use DSC analysis and a model Q1000 differential scanning calorimeter (TA Instruments, Inc.) to determine wt % of crystallinity (X %) with respect to the total weight of a hydrogenated styrenic block copolymer or film sample. General principles of DSC measurements and applications of DSC to studying semi-crystalline polymers are described in standard texts (e.g., E. A. Turi, ed., Thermal Characterization of Polymeric Materials, Academic Press, 1981).

Calibrate the model Q1000 differential scanning calorimeter first with indium and then with water in accord with standard procedures recommended for the Q1000 to ensure that heat of fusion (H_{f}) and onset of melting temperature for indium are within, respectively, 0.5 joules per gram (J/g) and 0.5° C. of prescribed standards (28.71 J/g and 156.6° C.) and that onset of melting temperature for water is within 0.5° C. of 0° C.

Press polymer samples into a thin film at a temperature of 230° C. Place a piece of the thin film that has a weight of from 5 milligrams (mg) to 8 mg in the differential scanning calorimeter's sample pan. Crimp a lid on the pan to ensure a closed atmosphere.

Place the sample pan in the differential scanning calorimeter's cell and heat contents of the pan at a rate of about 100° C./min to a temperature of 230° C. Maintain contents of the pan at that temperature for approximately three minutes, then cool the pan contents at a rate of 10° C./min to a temperature of −60° C. Keep the pan contents isothermally at −60° C. for three minutes and then heat the contents at a rate of 10° C./min up to 230 in a step designated as the “second heating”.

Analyze enthalpy curves that result from the second heating of polymer film samples as described above for peak melt temperature, onset and peak crystallization temperatures, and H_{f} (also known as heat of melting). Measure H_{f} in units of joules per gram (J/g) by integrating the area under the melting endotherm from the beginning of melting to the end of melting by using a linear baseline.

A 100% crystalline polyethylene has an art-recognized H_{f} of 292 J/g. Calculate wt % of crystallinity (X %) with respect to the total weight of a hydrogenated styrene block copolymer or film sample by using the following equation:

X%=(H_{f}/292)×100%

Determine 1,2-butadiene (also known as 1,2-vinyl) content of hydrogenated styrenic block copolymers prior to hydrogenation using Nuclear Magnetic Resonance (NMR) spectroscopy and a Varian INOVA™ 300 NMR spectrometer that operates with a pulse delay of 10 seconds to ensure complete relaxation of protons for quantitative integrations and samples of approximately 40 milligrams of polymer in one milliliter of deuterated chloroform (CDCl₃) solvent. Report chemical shifts relative to a tetramethylsilane (TMS) standard where chemical shifts for a 1,4-double bond region fall between 5.2 and 6.0 parts per million (ppm) and chemical shifts for a 1,2-double bond region fall between 4.8 ppm and 5.1 ppm. Integrate peaks in the 1,2-double bond region to determine a value, divide that value by two and designate that as “A”. Integrate peaks for the 1,4-double bond region to determine a second value, determine a difference between the second value and A, then divide the difference by two and designate that as “B”. Calculate the percent 1,2-vinyl or percent 1,2-butadiene content according to a formula as follows:

%1,2=(A/(A+B))×100%

Table 1 below summarizes hydrogenated styrenic block copolymer materials used in succeeding Ex and Comp Ex. In addition to the materials shown in Table 1, a material designated as H is a cyclic olefin polymer commercially available from Nippon Zeon under the trade designation ZEONOR™ 1060R. In Table 1, show 1,2-vinyl content (also known as 1,2-butadiene content) as a percentage relative to total butadiene content present in a polymer prior to hydrogenation.

TABLE 1

| | | | Pre-hydrogenation | | | |
|---|---|---|---|---|---|---|
| Material | Polymer | Mₙ (Before | Styrene Content | Nominal 1,2-vinyl | | T_{ODT} |
| Code | Structure | Hydrogenation) | (wt %) | Content (%) | X % | (° C.) |
| A | Pentablock | 55,000 | 55 | 8 | 9.3 | 255 |
| B | Pentablock | 60,000 | 75 | 8 | 4.3 | 210 |
| C | Pentablock | 59,000 | 53 | 11.3 | 6.6 | 185 |
| D | Pentablock | 60,000 | 60 | 12 | 7.4 | 225 |
| E | Pentablock | 65,000 | 60 | 8 | 9.0 | 295 |
| F | Pentablock | 60,000 | 85 | 8 | 1.5 | nm* |
| G | Triblock | 55,000 | 75 | 40 | 1.5 | 295 |

nm* means not measurable

### Ex 1

Using extruder operating conditions and melt cast parameters as shown in Table 2 below, convert Material A into an unstretched monolayer polymeric film having a target thickness of 50 micrometers (μm) or 2 mils (0.002 inch), also as shown in Table 2. In addition, Table 2 shows data for R₀ (in nm), R₀ standard deviation (in nm), Delta (n)(×10⁻³), slow optical axis (θ) (in degrees), and standard deviation of θ (in degrees, measured with respect to film extrusion direction). Delta (n)(×10⁻³)=R₀/d, where d=film thickness in μm. Delta (n) represents magnitude of birefringence in a film plane.

### Ex 2-23 and CEx A-E

Replicate Ex 1 with changes as shown in Table 2 below.

TABLE 2

| | | Film | | | | | | | | |
|---|---|---|---|---|---|---|---|---|---|---|
| | | Extrusion | | | | | | Slow | | |
| | | Temper- | Cast Roll | Film | | St | | Optical | | T_{ODT} |
| | | ature | Temper- | Thick- | | dev | | Axis, | Stdev | vs |
| Ex/ | | (FET) | ature | ness | R₀ | (R₀) | Delta (n) | θ | (θ) | FET |
| CEx | Resin | (° C.) | (° C.) | (μm) | (nm) | (nm) | (×10⁻³) | (°) | (°) | (° C.) |
| 1 | A | 265 | 90 | 50 | 122 | 11 | 2.4 | 0.5 | 0.3 | +10 |
| 2 | B | 221 | 85 | 50 | 112 | 4.1 | 2.2 | 0.4 | 0.2 | +11 |
| 3 | B | 230 | 87 | 50 | 78.2 | 4.3 | 1.6 | 0.4 | 0.3 | +20 |
| 4 | B | 238 | 87 | 50 | 44.1 | 2.9 | 0.9 | 0.8 | 0.5 | +28 |
| 5 | B | 229 | 87 | 100 | 70.9 | 4.7 | 0.7 | 1 | 0.7 | +19 |
| 6 | C | 185 | 93 | 50 | 240 | 11.3 | 4.8 | 2 | 1.2 | 0 |
| 7 | C | 196 | 93 | 50 | 132.8 | 13.5 | 2.7 | 3.9 | 2.3 | +11 |
| 8 | C | 196 | 82 | 50 | 119.5 | 8.7 | 2.4 | 0.6 | 0.4 | *11 |
| 9 | C | 196 | 68 | 50 | 119.8 | 3.4 | 2.4 | 1 | 0.6 | +11 |
| 10 | C | 196 | 52 | 50 | 131.1 | 5.8 | 2.6 | 2 | 1.2 | +11 |
| 11 | C | 210 | 73 | 50 | 76.4 | 4.3 | 1.5 | 1.8 | 0.4 | +25 |
| 12 | C | 213 | 74 | 50 | 39.7 | 3.4 | 0.8 | 0.6 | 0.6 | +28 |
| 13 | C | 213 | 84 | 50 | 44.7 | 3.2 | 0.9 | 0.5 | 0.4 | +28 |
| 14 | C | 213 | 84 | 100 | 35.5 | 4.9 | 0.7 | 2.7 | 1.3 | +28 |
| 15 | D | 229 | 90 | 50 | 133.6 | 6.4 | 2.7 | 0.4 | 0.3 | +4 |
| 16 | D | 235 | 90 | 50 | 101.4 | 5.2 | 2.0 | 0.6 | 0.5 | +10 |
| 17 | D | 241 | 90 | 50 | 70 | 4.9 | 1.4 | 1.3 | 0.8 | +16 |
| 18 | D | 246 | 90 | 50 | 58.4 | 5.4 | 1.2 | 1.6 | 1.2 | +21 |
| 19 | D | 254 | 90 | 50 | 32.1 | 3.2 | 0.6 | 2.4 | 1.5 | +29 |
| 20 | D | 229 | 90 | 75 | 141.9 | 9.2 | 1.9 | 0.7 | 0.5 | +4 |
| 21 | D | 235 | 90 | 75 | 102.5 | 6.2 | 1.4 | 0.8 | 0.6 | +10 |
| 22 | D | 241 | 90 | 75 | 73.1 | 5.6 | 1.0 | 2.2 | 1.3 | +16 |
| 23 | D | 246 | 90 | 75 | 50.5 | 3.9 | 0.7 | 2.5 | 1.4 | +21 |
| A | B | 246 | 87 | 50 | 18.9 | 2.8 | 0.4 | 1.3 | 1 | +36 |
| B | B | 255 | 87 | 50 | 4.9 | 2.2 | 0.1 | 8.4 | 11 | +45 |
| C | F | 266 | 50 | 100 | 1.6 | 0.9 | 0.1 | non- | *nm | −29 |
| | | | | | | | | uniform | | |
| D | G | 300 | 50 | 100 | 0.7 | 0.4 | 0.1 | non- | *nm | +5 |
| | | | | | | | | uniform | | |
| E | H | 226 | 50 | 100 | 3.9 | 6.9 | n/a | non- | *nm | *nm |
| | | | | | | | | uniform | | |

*nm means not measured

The data presented in Table 2 demonstrate that one can, by selecting styrenic block copolymers with a proper composition (i.e., Mₙ, % of styrene content) and microstructure (e.g., % of 1,2-vinyl content), prepare melt cast films with R₀ values that fall within a range of from 25 nm to about 250 nm (e.g. from 35.5 nm (Ex 14) to 240 nm (Ex 6)) without use of an additional orientation or stretching step. Moreover, film retardation (R₀) values are substantially uniform (Standard Deviation for R₀ of from 2.9 nm (Ex 4) to 13.5 (Ex 7) with eleven of fourteen examples showing a Standard Deviation for R₀ of less than 10 nm). In addition, the slow axis (in-plane) (θ) is nearly co-linear with film extrusion condition (i.e., machine direction) across the entire film area. The films of Ex 1-Ex 23 are suitable for use as a compensation film for viewing angle enhancement of a liquid crystal display or as an optical compensator for other display devices.

In contrast to Ex 1-23, when the percent of styrene in a hydrogenated styrenic block copolymer is greater than 80 wt % (Comp Ex C) or when the percent of 1,2-vinyl content in a hydrogenated styrene block copolymer is not less than 40 wt % (Comp Ex D), resulting films have an optical retardation value that is too low (respectively 1.6 nm and 0.7 nm) and displays a random or substantially non-uniform slow axis direction. Such films do not have sufficient properties to suggest their use as a compensation film without further processing, such as orientation.

Cyclic olefin polymer resins (Comp Ex E) also fail to yield melt cast films that have properties, particularly R₀ and θ, sufficient to allow their use, as cast, in compensation film applications. Based upon information and belief, such cyclic olefin polymer films require an additional processing step, predominantly stretching or orientation, in order to render them suitable for use in compensation film applications. As used herein, “cyclic olefin polymer” refers to a polymers that contains one or more monomer units (e.g. a homopolymer or a copolymer). See, e.g. Masahiro Yamazaki, “Industrialization and Application Development of Cyclo Olefin Polymer”, Journal of Molecular Catalysis A: Chemical, Volume 213, pages 81-87 (2004).

Data in Table 2 also demonstrate that melt processing conditions help determine whether a hydrogenated styrenic block copolymer film has an optical retardation that makes the film suitable for use as a compensation film. As shown by Comp Ex A-B relative to Ex 2 through Ex 4, all of which use the same resin, melt casting a film at a melt or extrusion temperature that is too high with respect to T_{ODT} (+36° C. for Comp Ex A and +45° C. for Comp Ex B) leads to an unstretched film retardation (R₀) that is too low to be useful in compensation film applications whereas melt casting at a lower temperature (+11° C. for Ex 2, +20° C. for Ex 3 and +28° C. for Ex 4) provides an unstretched R₀ that is useful for compensation film applications. Skilled artisans recognize that orientation or stretching of the films of Comp Ex A and Comp Ex B may increase the R₀ value sufficient to make them useful in compensation film applications. Skilled artisans also recognize that orientation or stretching adds to cost of manufacture.

### Ex 24-33 and CEx F

Replicate Ex 1 with changes as shown in Table 3 below to prepare a series of stretched films (Ex 24-33) from Resin E using an extrusion temperature of 272° C. (T_{ODT}−23° C., a cast roll temperature of 50° C. Each film has a thickness, prior to stretching, of 100 μm. Comp Ex F uses the same resin, extrusion temperature and cast roll temperature to prepare an unstretched film with a thickness of 100 μm. In Table 3, stretching is designated as machine direction (M), transverse direction (T) or biaxial (B). For purposes of Ex 24-33, M represents orthogonal axis X and corresponds to refractive index nx whereas T represents orthogonal axis Y and corresponds to refractive index ny.

TABLE 3

| | Stretching | | | | |
|---|---|---|---|---|---|
| | Temperature | Stretching | Draw | | Optical |
| Ex/CEx | (° C.) | Direction | Ratio | R₀ (nm) | Anisotropy |
| 24 | 130 | M | 1.3 | 121.2 | ny > nx |
| 25 | 130 | M | 1.5 | 199.6 | ny > nx |
| 26 | 130 | M | 2.5 | NM** | nx > ny |
| 27 | 130 | T | 1.3 | 176.5 | biaxial |
| 28 | 130 | T | 1.5 | 285.7 | biaxial |
| 29 | 130 | B | 1.3 | 219.8 | biaxial |
| 30 | 135 | M | 1.3 | 140.6 | ny > nx |
| 31 | 135 | M | 1.5 | 175 | ny > nx |
| 32 | 135 | B | 1.3 | 225 | biaxial |
| 33 | 135 | B | 1.5 | 137.3 | biaxial |
| F | n/a* | n/a* | n/a* | 36.2 | non- |
| | | | | | uniform |

n/a* means not applicable; NM** means not measured

The data presented in Table 3 support four observations. First, orientation or stretching can impart a uniform (non-random) optical anisotropy (Ex 24-Ex 33) to a film that otherwise has a random optical anisotropy (Comp Ex F). The non-uniform optical anisotropy of CEx F appears to result from extrusion at a temperature more than 20° C. below the T_{ODT} of Resin E. Skilled artisans understand that a uniform direction of optical anisotropy is an important requirement for compensation film applications. Second, orientation increases R₀ values. Third, one can generate a different in-plane optical anisotropy by simply varying draw ratio magnitude as shown in Ex 26 relative to Ex 24 and Ex 24. Based upon information and belief, this ability to change in-plane optical anisotropy by varying draw ratio magnitude appears to be unique to hydrogenated vinyl aromatic block copolymers. Fourth, Ex 27 and Ex 28 surprisingly show that biaxial anisotropy follows from uniaxial orientation or stretching as well as from biaxial orientation used in Ex 29.

1. An unstretched polymeric film, the film having a birefringence within a range of from 0.001 to 0.05, an in-plane retardation (R₀) within a range of from 25 nanometers to 500 nanometers at a wavelength of 633 nanometers, and, three mutually orthogonal refractive indices, nx, ny and nz, provided that one of the refractive indices has a magnitude that exceeds the other two refractive indices and constitutes a slow axis, the slow axis having a direction that is consistent, within a standard deviation of ten degrees, from one film region to another film region.

2. A stretched polymeric film, the film comprising a hydrogenated block copolymer that has a crystallinity of from 0.5 percent by weight to less than 20 percent by weight, based upon total film weight, and having a birefringence within a range of from 0.001 to 0.05 at a wavelength of 633 nanometers, and an in-plane retardation (R₀) within a range of from 25 nanometers to 500 nanometers at a wavelength of 633 nanometers.

3. The film of claim 1, wherein the film has an in-plane retardation (R₀) uniformity, in terms of standard deviation R₀, of no more than fifteen nanometers at a wavelength of 633 nm.

4. (canceled)

5. The film of claim 1, wherein the film comprises a block copolymer.

6. (canceled)

7. The film of claim 2, wherein the block copolymer is a hydrogenated vinyl aromatic/butadiene block copolymer in which both vinyl aromatic blocks and butadiene blocks are substantially fully hydrogenated.

8. (canceled)

9. (canceled)

10. (canceled)

11. The film of claim 7, wherein the vinyl aromatic/butadiene block copolymer is a styrene/butadiene block copolymer that has a styrene content, prior to hydrogenation, within a range of from 50 percent by weight to less than 80 percent by weight and a butadiene content within a range of from 50 percent by weight to 20 percent by weight, each percentage being based upon total block copolymer weight and, when taken together equal 100 percent by weight.

12. (canceled)

13. (canceled)

14. (canceled)

15. The film of claim 1, wherein the film is a monolayer film or at least one layer of a multilayer film.

16. The film of claim 5, wherein the film further comprises an amount of a non-block copolymer selected from a group consisting of hydrogenated vinyl aromatic homopolymers, polyolefins, cyclo olefin polymers, cyclo olefin copolymers, acrylic polymers, acrylic copolymers and mixtures thereof, the amount being within a range of from 0.5 percent by weight to 50 percent by weight, based upon combined weight of block copolymer and non-block copolymer.

17. (canceled)

18. (canceled)

19. (canceled)

20. (canceled)

21. The film of claim 1, further comprising an amount of an additive selected from a group consisting of retardation-enhancing agents, polarization-modifying agents, and dye molecules.

22. The film of claim 1, further comprising a coating on at least one major planar surface of the film.

23. The film of claim 22, wherein the coating comprises at least one additive selected from a group consisting of retardation-enhancing agents, polarization-modifying agents, and dye molecules.

24. A liquid crystal display comprising the film of claim 1.

25. (canceled)

26. An image display device comprising the film of claim 1.

27. A polarizer assembly comprising the film of claim 1.
